(19) United States
(12) Patent Application Publication
(10) Pub. No.: US 2018/0073572 A1
(43) Pub. Date: Mar. 15, 2018

(54) VARIABLE SPEED MECHANISM

(71) Applicant: BATOM CO., LTD., Taichung City (TW)

(72) Inventor: Norman Lien, Taipei City (TW)

(21) Appl. No.: 15/696,185

(22) Filed: Sep. 6, 2017

(30) Foreign Application Priority Data
Sep. 10, 2016 (TW) 105129500

(51) Int. Cl. F16D 23/12; F16D 13/52; F16H 3/089; F16H 25/18; F16D 13/38; F16D 21/00; F16D 23/02

(52) U.S. Cl. CPC F16D 23/12; F16D 13/52; F16H 3/089; F16H 2200/0034; F16D 13/385; F16D 21/00; F16D 23/02; F16H 25/18

(57) ABSTRACT

A variable speed mechanism includes at least two clutches provided on a driving shaft to allow for selectively driving, by using different ones of the clutches, transmission wheels having different gear ratios. Each of the clutches includes a clutching assembly and a ball arresting assembly that operates the clutching assembly. The ball arresting assembly includes a driving disc and a driven disc opposite to each other. The driving and driven discs have surface adjacent to each other and respectively formed with two curved guide grooves extending from a deep point to a shallow point. The curved guide grooves are provided with a guide bead arranged therein so that when the driving disc rotates with respect to the driven disc, the driven disc generates a movement of leaving or approaching the driving disc so as to achieve an engagement or disengagement operation of the clutching assembly.

### (a) TECHNICAL FIELD OF THE INVENTION

The present invention relates generally to the field of clutch of variable speed mechanisms, and more particularly to a variable speed mechanism based on mechanical engagement and disengagement operation to improve coupling power and reliability of engagement and disengagement and that allows for stepless lockup in order to reduce unnecessary wear and abrasion.

### (b) DESCRIPTION OF THE PRIOR ART

A variable speed mechanism achieves the purpose of speed variation by means of different gear ratio established with engagement conducted among gears of different diameters arranged between a driving shaft and a driven wheel. The speed variation of a conventional variable speed mechanism is generally based on an arrangement of at least two clutches on a driving shaft for respectively driving transmission wheels of different gear ratios to drive the driven wheel. Such clutches is made up of a clutching assembly and an arresting assembly, wherein the clutching assembly comprises a plurality of clamp plates connected to the driving shaft and a plurality of clamp plates connected to the transmission wheel, which are set in a stacking and mutually spaced arrangement, and the arresting assembly is operable to cause the clamp plates to tightly clamp or to separate from each other in order to achieve an operation of transmission.

The arresting assembly of the known clutch has various configurations of design, one of which involves an electromagnetic valve, wherein an electromagnetic valve that is arranged in front of the clutching assembly and is capable of reciprocal motion as energized by electrical power so that the linear movement of the electromagnetic valve drive a disc of the clutching assembly to selectively achieve tight engagement. However, since electrical components and wires must be arranged in the clutch, the entire structure becomes complicated and the width expanded. In addition, the operation power is supplied in the form of electromagnetic attraction forces, which provide limited forces acting on the clutching assembly so that the coupling or engagement force realized in the clutching assembly in weak, leading to numerous events of malfunctioning. In addition, manufacturing and assembling are difficult and thus, the cost is extremely high.

Another one of the various configurations of the arresting assembly involves a hydraulic assembly, which comprises a hydraulic pushing structure that is arranged in the clutching assembly of the clutch to generated, through hydraulic power, reciprocal motion so that the hydraulic pushing structure may drive the disc of the clutching assembly to selectively achieve tight engagement. However, a hydraulic channel must be provided inside the clutch, such as a hydraulic passage formed in the rotating shaft. This complicates the structure and also suffers compression ratio and quality deterioration of hydraulic fluid, leading to events of instability of pressure. Further, for the purpose of preventing undesired leaking, no high pressure may be involved and thus, the coupling or engagement power of the clutch may not be sufficient to meet desired levels. Further, there are numerous chances of malfunctioning and in addition, the same issue of high cost exists.

For clutches relying on arresting achieved with electromagnetic valve or hydraulic power, the driving or pushing force is generally very limited, and this leads to a limited coupling power, and thus, operation correctness and reliability are poor. Also, the structures are complicated, leading to issues of manufacturing and assembling, and also increasing the manufacturing cost.

Further, due to the complicated structures of the clutches of the variable speed mechanisms, it is generally impossible to provide a modularized configuration. Thus, to maintain or replace parts, all the parts must be removed one by one and this increases the difficulty and time of maintenance or part replacement, and a great amount of time would be wasted particularly for those clutches that are arranged internally. Further, the driving shaft is often locked for security purpose during car parking. A conventional way is to make a parking pawl selectively engage one of the tooth grooves. This way suffers incorrect positioning and local position shifting may result so that engagement and disengagement may readily cause wear and abrasion. It is desired to provide a solution that overcomes the above problems.

### SUMMARY OF THE INVENTION

Thus, the primary objective of the present invention is to provide a variable speed mechanism that has excellent operation correctness and provides an operation force for pushing a clutch achieved direct mechanical pushing so that the driving force is small; the pushing force is large, and the coupling force can be quickly established.

Another primary objective of the present invention is to provide a variable speed mechanism of high reliability, which has a simple structure, low malfunction rate, and allows for effective reduction of size and lowering down manufacturing cost.

A further primary objective of the present invention is to provide a modularized variable speed mechanism, which allows for assembly of a complete module so that for needs of maintenance or replacement, the clutch can be removed or installed in a one time manner, whereby the operation is easy and convenient so as to effectively reduce maintenance time and improve efficiency.

Yet a further primary objective of the present invention is to provide variable speed mechanism allowing for car parking, wherein at least two clutches are synchronously coupled so as to lock a driving shaft by means of different gear ratios.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view showing a first clutch of the present invention, illustrating configurations and spatial relationships of parts thereof. FIG. 2A is an exploded view showing a ball arresting assembly of the first clutch of the present invention.

FIG. 3 is an exploded view showing a second clutch of the present invention, illustrating configurations and spatial relationships of parts thereof.

FIG. 3A is an exploded view showing a ball arresting assembly of the second clutch of the present invention.

FIG. 4 is a cross-sectional view of the present invention in an assembled form.

FIG. 5 is a schematic view illustrating an operation of switching to a first speed by means of the first clutch in an actual use of the present invention.

FIG. 6 is a schematic view illustrating an operation of switching to a second speed by means of the second clutch in an actual use of the present invention.

FIG. 7 is a schematic view illustrating an operation of achieving a car-parking condition by means of the first and second clutches in an actual use of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

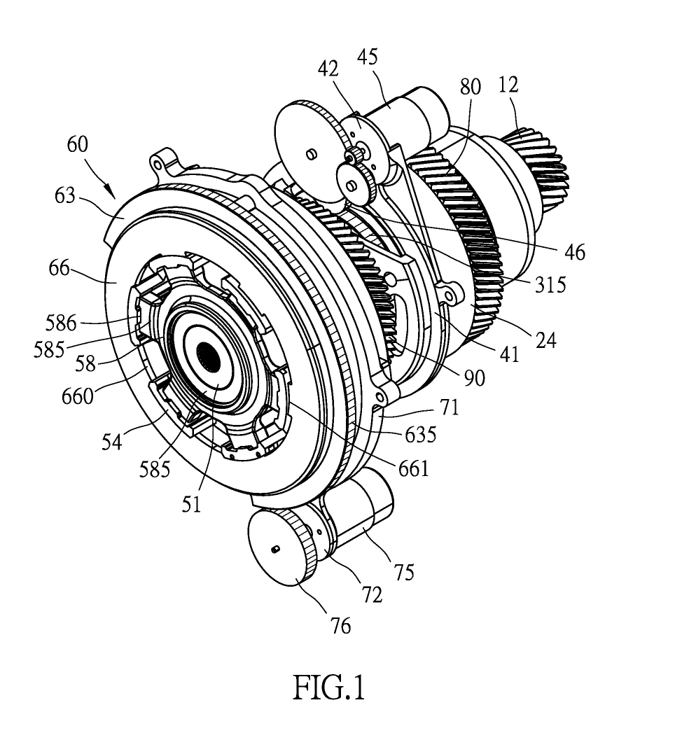

The structure of the present invention, as shown in FIG. 1, is such that a variable speed mechanism is provided, on a driving shaft 10, with at least two clutches 2, 5 for using the different clutches 2, 5 to selectively drive at least two corresponding transmission wheels 80, 90 having different numbers of teeth so as to drive, through the transmission wheels 80, 90, a driven wheel (not shown in the drawings) to make the driven wheel generating different rotational speeds;

the clutches 2, 5 are arranged between the driving shaft 10 and the first and second transmission wheels 80, 90 to selectively make the driving shaft 10 and the first and second transmission wheels 80, 90 generate inter-connecting relationship, and further, the clutches 2, 5 are made up of a clutching assembly 20, 50 and a ball arresting assembly 30, 60 that operates the clutching assembly 20, 50, the present invention being characterized in that the ball arresting assembly 30, 60 at least comprises a driving disc 31, 63 and a driven disc 32, 64 corresponding to each other and adjacent surfaces of the driving and driven discs 31, 32/63, 64 are respectively and correspondingly formed with at least two curved guide grooves 311, 321/631, 641 of equal distance and varying from deepness to shallowness, and further, the corresponding curved guide grooves 311, 321/631, 641 of the driving and driven discs 31, 32/63, 64 are respectively provided therein with a guide bead 33, 65 so that when the driving disc 31, 63 is rotate relative to the driven disc 32, 64, the driven disc 32, 64 generates a linear motion of leaving or approaching with respect to the driving disc 31, 63 to correspondingly operate the clutching assembly 20, 50 to generate an operation of engagement or disengagement.

Referring to FIGS. 1-4, the present invention is exemplified with a primary embodiment involving two clutches 2, 5 and two transmission wheels 80, 90, wherein the two clutches 2, 5 are respectively define as a first clutch 2 and a second clutch 5 and the two transmission wheels 80, 90 are respectively defined as a first transmission wheel 80 and a second transmission wheel 90, and the driving shaft 10 comprises a primary toothed section 11 at one end thereof for mounting a driving wheel 12 and the driving shaft 10 comprises, at an opposite end thereof, a first toothed section 13 and a second toothed section 15 respectively for engagement with the first and second clutches 2, 5, and the driving shaft 10 is formed, between the first and second toothed sections 13, 15, with a stepped shaft section 14;

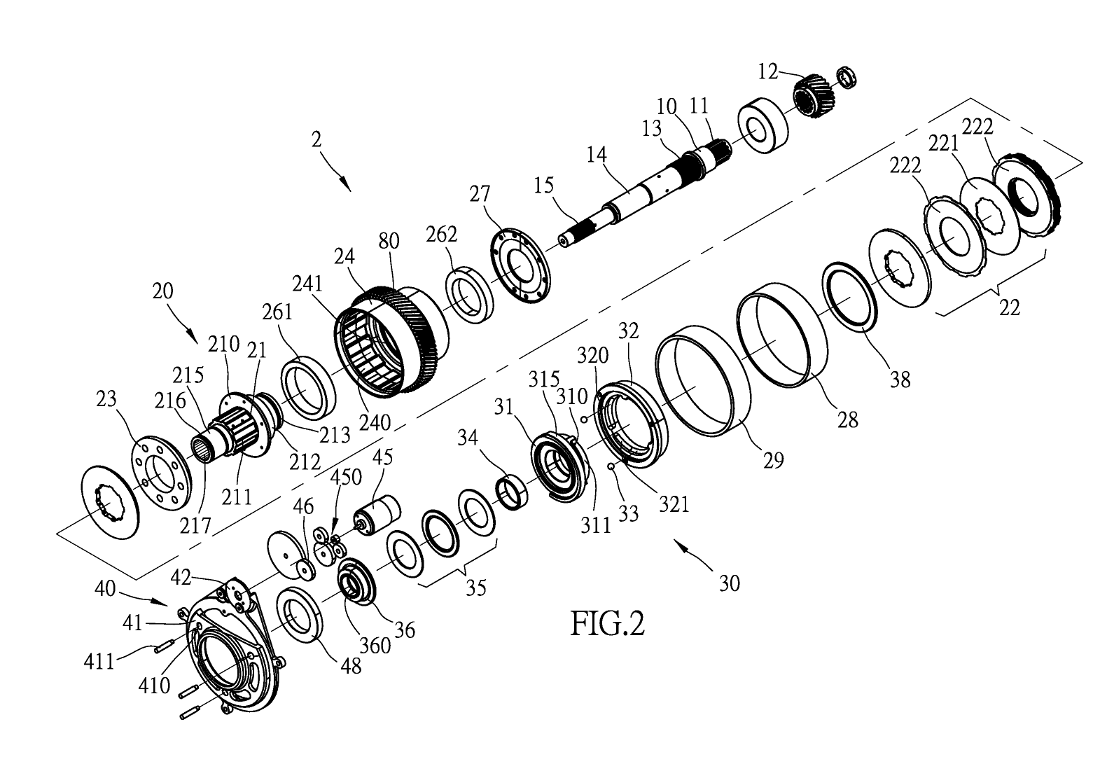

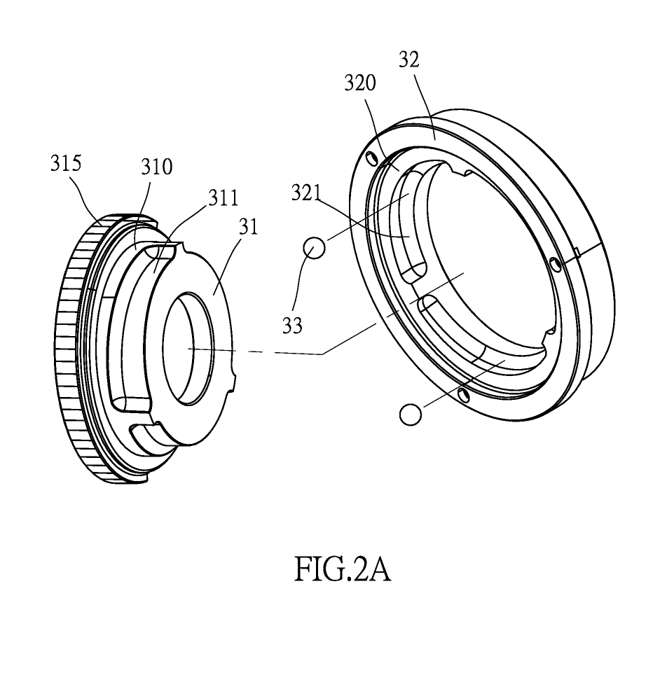

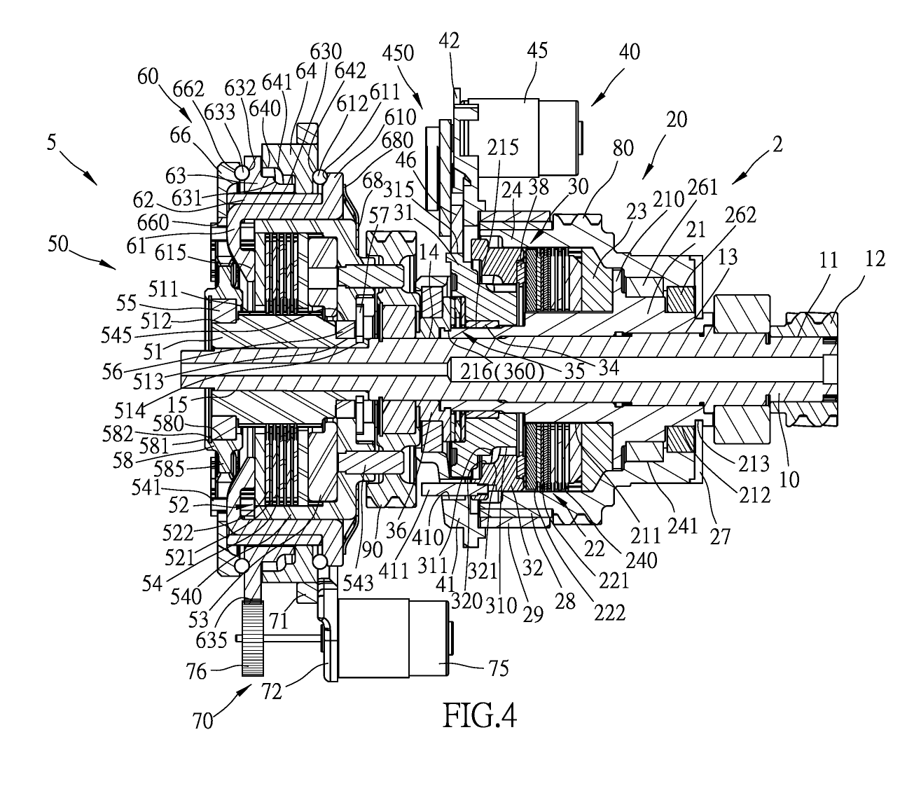

the first clutch 2 is made up of a clutching assembly 20 and a ball arresting assembly 30 that operates the clutching assembly 20, and as shown in FIGS. 2 and 4, the clutching assembly 20 at least comprises an inner tooth sleeve 21, a lining assembly 22, and an outer enclosure sleeve 24, a central toothed hole 217 of the inner tooth sleeve 21 being engageable with the first toothed section 13 of the driving shaft 10 to allow the driving shaft 10 to drive the inner tooth sleeve 21 to rotate in synchronization therewith, and the inner tooth sleeve 21 comprises a radius-expanded projecting stop flange 210, and the inner tooth sleeve 21 is formed, on an outer circumference thereof, with axially-extending elongated teeth 211, and further, the inner tooth sleeve 21 is formed, on an outer circumference thereof on one side of the projecting stop flange 210 that is opposite to the elongated teeth 211, with a rear stepped section 212 and a rear position-constraining annular slot 213, wherein the rear stepped section 212 is provided for mounting a one-way bearing 261 and a thrust bearing 262 that are arranged in the outer enclosure sleeve 24 and the rear position-constraining annular slot 213 is provided for receiving an inner circumference of a pressing lid 27, which is in the form of an annular lid made of two parts mating with and jointed to each other, to fit therein, and the inner tooth sleeve 21 is formed, on an outer circumference of one end of the elongated teeth 211 that is opposite to the projecting stop flange 210, with a front stepped section 215 and a front position-constraining annular slot 216 for mounting the ball arresting assembly 30, and the outer enclosure sleeve 24 is formed, on an inner circumference thereof, with a plurality of raised tooth bars 240 corresponding to the elongated teeth 211 of the inner tooth sleeve 21, and the outer enclosure sleeve 24 is formed, on a rear portion of the inner circumference thereof, with a stepped shaft hole 241 for mounting the one-way bearing 261 and the thrust bearing 262 so that the outer enclosure sleeve 24 is allow to do one-way rotation with respect to the inner tooth sleeve 21 and the first transmission wheel 80 is mounted on the outer enclosure sleeve 24, either in an integrated unitary structure or in a two-piece structure;

the lining assembly 22 is made up of a series of first clamp plates 221 and a series of second clamp plates 222 that are arranged adjacent to each other, wherein the first clamp plates 221 comprises engagement teeth formed on an inner circumference thereof and engageable with the elongated teeth 211 of the inner tooth sleeve 21 and the second clamp plates 222 comprises engagement teeth formed on an outer circumference thereof and engageable with the raised tooth bars 240 formed on the inner circumference of the outer enclosure sleeve 24 so that when the first and second clamp plates 221, 222 of the lining assembly 22 are set in tight engagement with each other, the inner tooth sleeve 21 may drive the outer enclosure sleeve 24 in synchronization therewith, otherwise when the first and second clamp plates 221, 222 are not in tight engagement with each other, the inner tooth sleeve 21 does not drive the outer enclosure sleeve 24, and further, an elastic body 23 is arranged between the lining assembly 22 and a rear wall surface of the outer enclosure sleeve 24 for providing an effect of position returning and compensative energy accumulation when the lining assembly 22 compresses the elastic body 23 and the outer circumference of the outer enclosure sleeve 24 receives, through a lining sleeve 28, an outer casing 29 to fit thereto for jointing with other components;

the ball arresting assembly 30 comprises a driving disc 31 and a driven disc 32, wherein the driving disc 31 is rotatably mounted, by means of a lining sleeve 34 and a lining plate assembly 35, to the front stepped section 215 of the inner tooth sleeve 21, and with reference to FIG. 2A, the driving and driven discs 31, 32 are respectively formed, on surfaces thereof that face each other, with stepped annular surfaces 310, 320 that correspond to each other and opposite vertical faces of the stepped annular surfaces 310, 320 are formed, respectively, with at least two curved guide grooves 311, 321 from deepness to shallowness and having similar depth contour and opposite to each other, and further, the opposite curved guide grooves 311, 321 comprise a guide bead 33 interposed therebetween so that forward and backward rotation between the driving and driven discs 31, 32, in combination with the guide bead 33, generate a motion of leaving or approaching each other, and wherein a spacer plate 38 is arranged between the driven disc 32 and the lining assembly 22 of the clutching assembly 20 for reducing wear and abrasion and further, the ball arresting assembly 30 comprises a shaft sleeve 36 that is formed of two semi-circles mating and jointed to each other and mounted to the front stepped section 215 of the inner tooth sleeve 21, and the shaft sleeve 36 is formed, on an inner circumference thereof, with a retention rim 360 corresponding to the front position-constraining annular slot 216 of the front stepped section 215 to allow for modularization of the clutching assembly 20;

the ball arresting assembly 30 is further provided with a driving assembly 40 that operates the driving disc 31, and the driving assembly 40 comprises a fixing lid 41 that is fit, through a bearing 48, to the shaft sleeve 36 of the ball arresting assembly 30, the fixing lid 41 comprising a plurality of guide holes 410 set at equal angular interval, the guide holes 410 respectively receiving guide posts 411 formed on a corresponding surface of the driven disc 32 of the ball arresting assembly 30 to slidably extend therethrough so that the driven disc 32 is allowed for frontward-rearward linear movement with respect to the driving disc 31, and further, the fixing lid 41 comprises a fixing plate 42, and the fixing plate 42 is provided with a servo motor 45 mounted thereto and the servo motor 45 comprises a driving gear 46 that is operated through a reduction assembly 450, the driving gear 46 corresponding to the driving disc 31 of the ball arresting assembly 30, the driving disc 31 having a circumference that comprises an engagement toothed section 315 that engages with the driving gear 46 so that the servo motor 45 may selectively operate the driving disc 31 of the ball arresting assembly 30 to rotate forward and backward so as to operate, through the guide bead 33, the driven disc 32 to move frontward and backward;

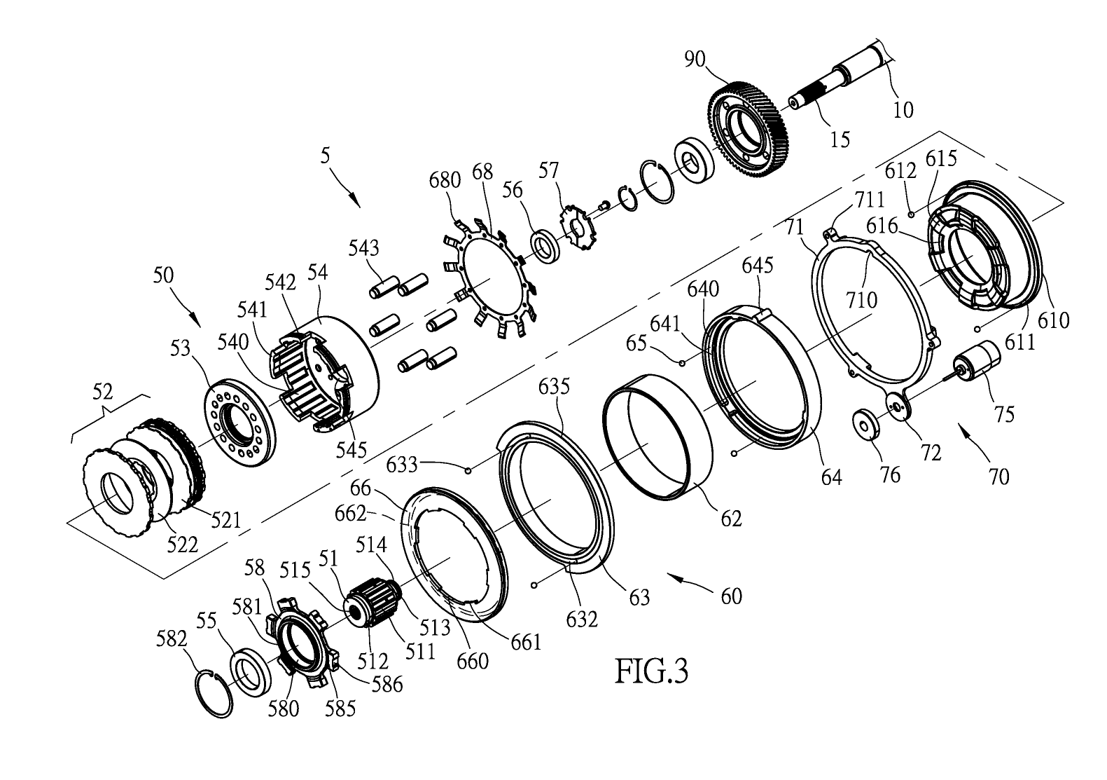

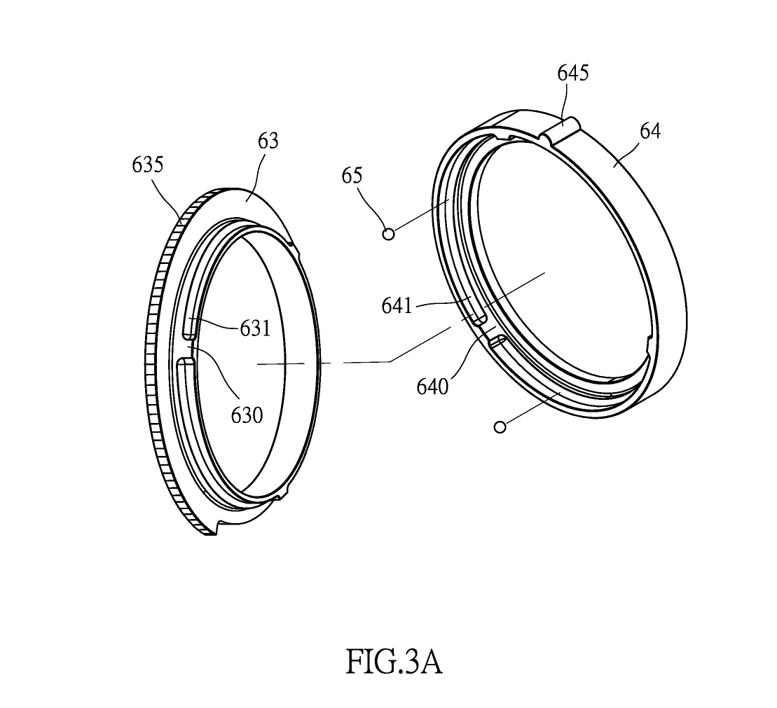

the second clutch 5 is arranged between the driving shaft 10 and the second transmission wheel 90 to selectively make the driving shaft 10 and the second transmission wheel 90 generate inter-connecting relationship, and further, the second clutch 5 is made up of the clutching assembly 50 and the ball arresting assembly 60 that operates the clutching assembly 50, and with reference to FIGS. 3 and 4, the clutch 5 is made up of the clutching assembly 50 and the ball arresting assembly 60 that operates the clutching assembly 50, wherein the clutching assembly 50 at least comprises an inner tooth sleeve 51, a lining assembly 52, an outer enclosure sleeve 54 having an opening, and a radial support member 58, a central toothed hole 515 of the inner tooth sleeve 51 being engageable with the second toothed section 15 of the driving shaft 10 to allow the driving shaft 10 to drive the inner tooth sleeve 51 to rotate in synchronization therewith, and the inner tooth sleeve 51 is formed, on an outer circumference thereof, with an axially-extending elongated teeth 511, and further, the inner tooth sleeve 51 are formed, on outer circumferences of two opposite ends thereof, with stepped sections 512, 513, respectively, for rotatably supporting, through a front thrust bearing 55 and a rear thrust bearing 56, respectively, the radial support member 58 and the outer enclosure sleeve 54, so that the outer enclosure sleeve 54 and the radial support member 58 are rotatable with respect to the inner tooth sleeve 51, and further, the lining assembly 52 is made up of a series of second clamp plates 521 and a series of first clamp plates 522, wherein the first clamp plates 522 comprises engagement teeth formed on an inner circumference thereof and engageable with the elongated teeth 511 of the inner tooth sleeve 51 and the second clamp plates 521 are engageable with the inner circumference of the outer enclosure sleeve 54 so that when the second and first clamp plates 521, 522 of the lining assembly 52 are set in tight engagement with each other, the inner tooth sleeve 51 may drive the outer enclosure sleeve 54 in synchronization therewith, otherwise when the second and first clamp plates 521, 522 are not in tight engagement with each other, the inner tooth sleeve 51 does not drive the outer enclosure sleeve 54, and further, the outer enclosure sleeve 54 is formed, on the inner circumference thereof, with a series of raised tooth bars 540 for engagement with engagement teeth formed on an outer circumference of the second clamp plates 521 of the lining assembly 52, and further, an elastic body 53 is arranged between the lining assembly 52 and a rear wall surface of the outer enclosure sleeve 54 for providing an effect of position returning and compensative energy accumulation when the lining assembly 52 compresses the elastic body 53;

the open end of the outer enclosure sleeve 54 is formed, on a circumference thereof, with a plurality of projection blocks 541 arranged at equal interval, and the outer enclosure sleeve 54 is formed, on an outer edge of each of the projection blocks 541, with an annular engagement slot 542 corresponding to each for engagement with the outer disc 66 of the ball arresting assembly 60, and further, a wall surface of the outer enclosure sleeve 54 that is opposite to the opening is provided with a plurality of transmission rods 543 for connection with the second transmission wheel 90, and further, the wall surface of the outer enclosure sleeve 54 is formed, in a center thereof, with a shaft seat hole 545 for mounting the rear thrust bearing 56, and further, the inner tooth sleeve 51 is provided, in the rear-end stepped section 513, with a position-constraining annular slot 514 extending beyond the rear thrust bearing 56 to allow two pressing plates 57 that are received in the position-constraining annular slot 514 of the inner tooth sleeve 51 to be mounted to the rear wall surface of the outer enclosure sleeve 54 so that the outer enclosure sleeve 54 and the rear end of the inner tooth sleeve 51 are coupled together, the radial support member 58 being formed, in a center thereof, with a stepped shaft seat hole 580 for mounting the front thrust bearing 55, and further, the shaft seat hole 580 is formed, in an inner circumference thereof at a location adjacent to a front end, with a retention groove 581 to receive a retention ring 582 to fit therein to retain the front thrust bearing 55 on the radial support member 58, and further, the radial support member 58 comprises a plurality of rib strips 585 that are different, in position, from the projection blocks 541 of the outer enclosure sleeve 54, and the rib strips 585 are each provided, on a top end thereof, with a fitting tooth groove 586 corresponding to the projecting retention block 661 of the inner hole 660 of the outer disc 66 so that the radial support member 58 and the outer disc 66 are retained together and rotatable in synchronization with each other;

the ball arresting assembly 60 comprises a pushing member 61 that is fit over an outer circumference of the outer enclosure sleeve 54 of the clutching assembly 50 and the pushing member 61 comprises, corresponding to a rear end, an annular stop plate 610 projecting therefrom and the annular stop plate 610 is formed, on a front surface therefo, with an annular bead groove 611, and further, the pushing member 61 is formed, on a front end thereof, with a push plate 615 that is curved inward and set to abut, in a rearward direction, the lining assembly 52, and further, the push plate 615 is formed with a plurality of through holes 616 respectively corresponding to the projection blocks 541 of the open end of the outer enclosure sleeve 54 for extension of the projection blocks 541 of the open end of the outer enclosure sleeve 54 therethrough to allow the pushing member 61 to be movable frontward and rearward on the outer enclosure sleeve 54, and further, the pushing member 61 has an outer circumference to which a lining sleeve 62 is fit, and further, the ball arresting assembly 60 comprises a driving disc 63 and a driven disc 64 arranged on the lining sleeve 62, and with reference to FIG. 3A, the driving and driven discs 63, 64 are formed, respectively, on end surfaces thereof facing each other, with stepped annular surfaces 630, 640 that correspond to each other and opposite vertical faces of the stepped annular surfaces 630, 640 are formed, respectively, at least two curved guide grooves 631, 641 from deepness to shallowness and having similar depth contour and opposite to each other, and further, the opposite curved guide grooves 631, 641 comprise a guide bead 65 interposed therebetween so that forward and backward rotation between the driving and driven discs 63, 64, in combination with the guide bead 65, generate a motion of leaving or approaching each other, wherein the driven disc 64 is formed, on a surface thereof opposite to the annular bead groove 611 of the annular stop plate 610 of the pushing member 61, with a corresponding annular bead groove 642 for receiving at least two corresponding rolling beads 612 to roll therein, and further, the ball arresting assembly 60 is provided, on one side of the driving disc 63 that is opposite to the driven disc 64, with an outer disc 66, and the outer disc 66 comprises an inner hole 660 corresponding to the outer enclosure sleeve 54, the inner hole 660 being receivable in the annular engagement slots 542 of the outer enclosure sleeve 54 so that the ball arresting assembly 60 is positioned-constrained on the outer enclosure sleeve 54 of the clutching assembly 50 by the outer disc 66, and further, the driving disc 63 and the outer disc 66 are formed, respectively, on surfaces thereof that are adjacent to each other, with annular bead grooves 632, 662 corresponding to each other to receive at least two corresponding rolling beads 633 to roll therein, and further, the ball arresting assembly 60 comprises an elastic annular plate 68 fixed to a rear wall surface of the outer enclosure sleeve 54, and the elastic annular plate 68 has a circumference that comprises a plurality of position-returning spring plates 680 in radiating form and abutting a rear wall surface of the pushing member 61 to generate a position-returning pre-loading force after the pushing member 61 is pushed and allow for modularization;

the ball arresting assembly 60 is further provided with a driving assembly 70 that is operable to rotate the driving disc 63, and the driving assembly 70 comprising a fixing annular cover 71 that is fit over the driven disc 64 of the ball arresting assembly 60 and has a circumference that comprises a plurality of fixing projection blocks 711 for fixing, and an inner circumference of the fixing annular cover 71 and an outer circumference of the driven disc 64 are respectively formed with at least one set of corresponding guide sections 710, 645 that are of a projection-recess mating arrangement so that the driven disc 64 is allowed to move frontward and rearward with respect to the fixing annular cover 71, and further, the fixing annular cover 71 comprises a fixing plate 72 formed thereon and the fixing plate 72 comprises a servo motor 75 mounted thereto, and the servo motor 75 has an output shaft that comprises a driving gear 76 corresponding to the driving disc 63 of the ball arresting assembly 60, and the driving disc 63 has a circumference that comprises an engagement toothed section 635 engageable with the driving gear 76 so that the servo motor 75 may selectively operate the driving disc 63 of the ball arresting assembly 60 to rotate forward and backward;

whereby a variable speed mechanism that has a simple structure, good operation correctness, high reliability, small driving force and large pushing force, and allowing for car-parking operation is provided.

In an actual operation of the present invention, as shown in FIGS. 1 and 4, speed variation is allowed among a neutral position, a first speed position, a second speed position, and a car-parking position. Taking the neutral position as an example, the ball arresting assemblies 30, 60 of both the first and second clutches 2, 5 are idle and the guide beads 33, 65 of the ball arresting assemblies 30, 60 are respectively located at a deepest position in the curved guide grooves 311, 631 of the driving discs 31, 63 and the curved guide grooves 321, 641 of the driven disc 32, 64 so that the driven discs 32, 64 are close to the driving discs 31, 63 and do not push the lining assemblies 22, 52 of the clutching assemblies 20, 50, setting the lining assemblies 22, 52 are in an engagement condition, allowing the inner tooth sleeves 21, 51 and the outer enclosure sleeves 24, 54 of the first and second clutches 2, 5 to be in idle condition, whereby the driving shaft 10 does not drive the first and second transmission wheels 80, 90, providing a condition of neutral position.

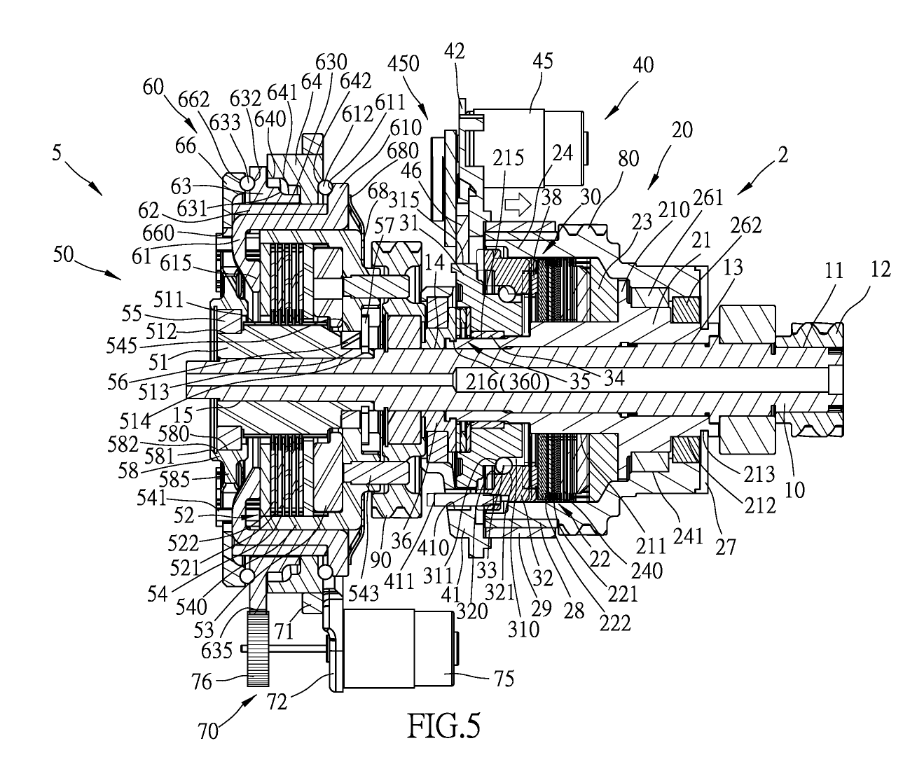

To operate with the first speed position, as shown in FIGS. 4 and 5, the second clutch 5 is in an inoperative condition and the servo motor 45 of the driving assembly 40 of the first clutch 2 is activated to have the driving gear 46 drive the driving disc 31 of the ball arresting assembly 30 to rotate and the guide bead 33 between the driving and driven discs 31, 32 is moved to a shallowest position of the curved guide grooves 311, 321 between the two so that the driven disc 32 is pushed backward to further push, via the driven disc 32, the lining assembly 22 of the clutching assembly 20 and the first and second clamp plates 221, 222 are caused to get tight engagement with each other so that the driving shaft 10 drives, in synchronization therewith, the first transmission wheel 80 through the inner tooth sleeve 21, the lining assembly 22 and the outer enclosure sleeve 24 to provide the first speed position. Further, the lining assembly 22 compresses the elastic body 23 to generate a position-returning pre-loading force so that when the servo motor 45 operates the driving disc 31 to rotate reversely, returning is made back to the condition where the first and second clamp plates 221, 222 of the lining assembly 22 are not in tight engagement to allow for cyclic operation of engagement and disengagement.

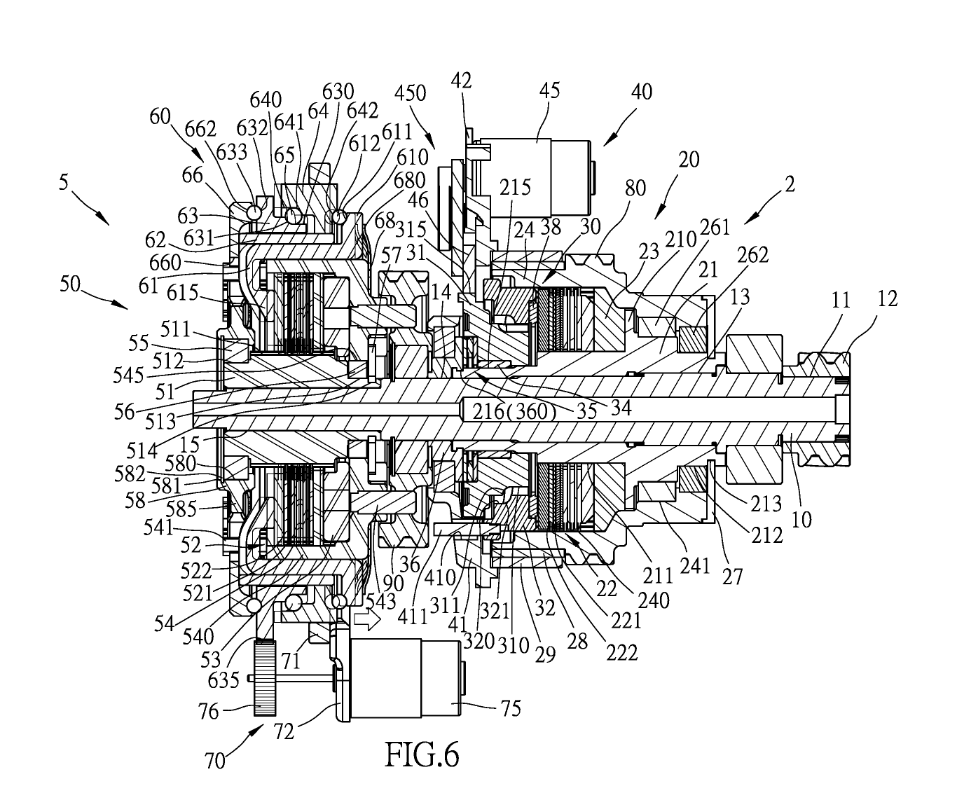

To operate with the second speed position, as shown in FIGS. 4 and 6, the first clutch 2 is in an inoperative condition and the servo motor 75 of the driving assembly 70 of the second clutch 5 is activated to have the driving gear 76 drive the driving disc 63 of the ball arresting assembly 60 to rotate and the guide bead 65 between the driving and driven discs 63, 64 is moved to a shallowest position of the curved guide grooves 631, 641 between the two so that the driven disc 64 is pushed backward to further push, via the driven disc 64, the pushing member 61, and the push plate 615 of the pushing member 61 pushes, in synchronization therewith, the lining assembly 52 of the clutching assembly 50 to make the second and first clamp plates 521, 522 in tight engagement with each other so that the driving shaft 10 drives, in synchronization therewith, the second transmission wheel 90 through the inner tooth sleeve 51, the lining assembly 52, and the outer enclosure sleeve 54 to provide the second speed position. Further, the lining assembly 52 compresses the elastic body 53 and the pushing member 61 also, at the same time, compresses the position-returning spring plates 680 of the elastic annular plate 68 to generate a position-returning pre-loading force so that when the servo motor 75 operates the driving disc 63 to rotate reversely, returning can similarly made back to the condition where the second and first clamp plates 521, 522 of the lining assembly 52 are not in tight engagement to allow for cyclic operation of engagement and disengagement.

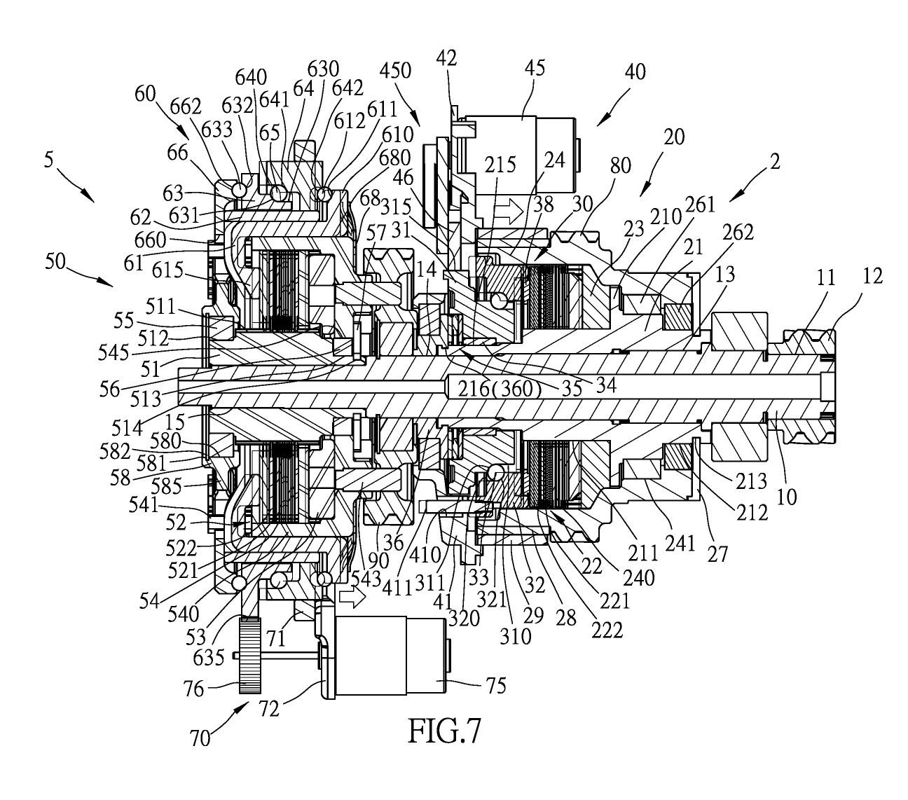

To carry out a car-parking operation, as shown in FIGS. 4 and 7, the first and second clutches 2, 5 are put into operations each in the same way as described above so that the ball arresting assemblies 30, 60 of the first and second clutches 2, 5 simultaneously push the lining assemblies 22, 52 of the clutching assemblies 20, 50 into tight engagement to have the driving shaft 10 simultaneously engage with both the first and second transmission wheels 80, 90, and due to the different gear ratios of the first and second transmission wheels 80, 90, the driving shaft 10 in a reverse direction thereby a car-parking locked condition in a stepless way is achieved, and this, compared to the known arrangements involving engagement groove and engagement tooth, makes the locking operation performable in a smooth way and helps reduce unnecessary wear and abrasion to thereby extend the service life thereof.

Further, as shown in FIG. 4, in the present invention, the first clutch 2 is structured such that modularization can be achieved for the entirety of the first clutch 2 by means of the arrangement of the outer enclosure sleeve 24 of the clutching assembly 20, as well as the thrust bearing 262 and the pressing lid 27 arranged rearward thereof and the shaft sleeve 36 of the ball arresting assembly 30 arranged frontward thereof, and the second clutch 5 is structured such that modularization can be achieved for the clutching assembly 50 of the second clutch 5 and the ball arresting assembly 60 that form a complete module by means of an arrangement of the outer enclosure sleeve 54, as well as the rear thrust bearing 56 and the pressing plates 57 arranged rearward thereof and the radial support member 58 arranged frontwards thereof, in combination with the pushing member 61, the elastic annular plate 68, and the outer disc 66 of the ball arresting assembly 60. As such, in needs of maintenance or parts replacement for the first and second clutches 2, 5, the first and second clutches 2, 5 can be removed from or installed on the driving shaft 10 through one-time operation so that the operation is easy and convenient and an operator is allowed to remove the entire assembly of the first and second clutches 2, 5 for replacement with a new assembly of the first and second clutches 2, 5 to allow for performance of operation of a device, while the removed, used first and second clutches 2, 5 can be kept for subsequent maintenance and repair in later time to thereby effectively save time of maintenance and repairing and improve efficiency.

In the present invention, the first and second clutches 2, 5 uses the guide beads 33, 65 between the driving discs 31, 63 and the driven discs 32, 64 of their own individual ball arresting assemblies 30, 60 to achieve selective engagement of each of the clutching assemblies 20, 50 for variation among different speeds, wherein the structure is simple, malfunctioning rate is low, the size is effectively reduced, and the manufacturing cost is lowered down, and further, the pushing force is achieved with mechanical direct pushing so that the driving force is small and the pushing force is large, allowing for increasing and quickly establishing the coupling force for the lining assembly 22, 52 of each of the first and second clutches 2, 5 of the variable speed mechanism to thereby improve operation correctness and reliability; and

further, a unique design is provided, involving the elastic bodies 23, 53 arranged between the lining assemblies 22, 52 and the outer enclosure sleeves 24, 54 of the first and second clutches 2, 5, to form an energy accumulation or storage structure, wherein when the lining assemblies 22, 52 suffer wear to some extents, an adjustment can be automatically realized to increase a feeding distance and achieve compensation of motor torque so that there is no need to conduct a complicated operation of adjusting the servo motors thereby greatly improve utilization thereof.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A variable speed mechanism, wherein the variable speed mechanism is provided, on a driving shaft, with at least two clutches for using the different clutches to selectively drive at least two corresponding transmission wheels having different gear ratios so as to drive, through the transmission wheels, a driven wheel to generate different rotational speeds, the clutches each comprising at least a clutching assembly and a ball arresting assembly;
wherein the clutching assembly comprises a lining assembly, and the lining assembly comprises a plurality of clamp plates that are arranged adjacent to each other and are respectively coupled to the driving shaft and a corresponding one of the transmission wheels so that the clamp plates, when selectively compressed, get in tight engagement to allow the driving shaft to drive the corresponding one of the transmission wheels;
the ball arresting assembly is arranged at one side of the clutching assembly to selectively compress and push the lining assembly, and the ball arresting assembly at least comprises a driving disc and a driven disc corresponding to each other, the driving and driven discs having vertical faces opposite to each other and respectively formed with at least two curved guide grooves from deepness to shallowness and having similar depth contour, a guide bead being interposed between the corresponding curved guide grooves of the driving and driven discs; and
the driving disc is rotatable with respect to the driven disc such that the guide bead rolls in the corresponding curved guide grooves between a shallowest position and a deepest position to allow the driven disc to generate a linear motion of leaving or approaching with respect to the driving disc for pushing the lining assembly of the clutching assembly to get into engagement or disengagement.

2. The variable speed mechanism according to claim 1, wherein the lining assembly of the clutching assembly is provided, on one side thereof, with an elastic body so that compression of the elastic body by the lining assembly generate accumulation compensating pressure.

3. A variable speed mechanism, wherein the variable speed mechanism is provided, on a driving shaft, with a first clutch and a second clutch for using the first clutch and the second clutch to selectively drive a first transmission wheel and a second transmission wheel corresponding thereto and having different gear ratios so as to drive, selectively through the first and second transmission wheels, a driven wheel to generate different rotational speeds;
wherein the first clutch is arranged between the driving shaft and the first transmission wheel and the first clutch at least comprises a clutching assembly and a ball arresting assembly, wherein the clutching assembly of the first clutch at least comprises an inner tooth sleeve, a lining assembly, and an outer enclosure sleeve, the inner tooth sleeve being engageable, at a center thereof, with the driving shaft, the outer enclosure sleeve being mounted, through a one-way bearing and a thrust bearing, to the inner tooth sleeve, the lining assembly of the clutching assembly of the first clutch comprising a plurality of first clamp plates and second clamp plates that are arranged adjacent to each other and are respectively coupled to an outer circumference of the inner tooth sleeve and an inner circumference of the outer enclosure sleeve for being selectively compressed to get in tight engagement, the outer enclosure sleeve being coupled to the first transmission wheel;
the ball arresting assembly of the first clutch comprises a driving disc and a driven disc rotatably mounted to a front end of the inner tooth sleeve, the driving and driven discs having vertical faces that are opposite to each other and are respectively formed with at least two curved guide grooves having identical depth contour extending from a deep end to a shallow end and opposite to each other, the opposite curved guide grooves comprising a guide bead interposed therebetween so that forward and backward rotation between the driving and driven discs generate movements of leaving and approaching each other, respectively;
the second clutch is arranged between the driving shaft and the second transmission wheel and the second clutch at least comprises a clutching assembly and a ball arresting assembly, wherein the clutching assembly of the second clutch at least comprises an inner tooth sleeve, a lining assembly, an outer enclosure sleeve having an opening, and a radial support member, the inner tooth sleeve being engageable, at a center thereof, with the driving shaft, the radial support member and the outer enclosure sleeve having centers respectively and rotatably mounted to two ends of the inner tooth sleeve, the lining assembly of the clutching assembly of the second clutch comprising a plurality of first clamp plates and second clamp plates that are arranged adjacent to each other and are respectively coupled to an outer circumference of the inner tooth sleeve and an inner circumference of the outer enclosure sleeve for being selectively compressed to get in tight engagement, the open end of the outer enclosure sleeve being formed, on a circumference thereof, with a plurality of equally-spaced projection blocks, the outer enclosure sleeve being coupled to the second transmission wheel; and
the ball arresting assembly of the second clutch comprises a pushing member fit to an outer circumference of the outer enclosure sleeve of the clutching assembly of the second clutch, the pushing member being extended, corresponding to a rear end, to form an annular stop plate, the pushing member having a front end that is formed with a push plate that is curved inwardly for extension through and abutting, in a rearward direction, the lining assembly, the push plate being formed with a plurality of through holes respectively corresponding to the projection blocks of the circumference of the open end of the outer enclosure sleeve, the outer enclosure sleeve being provided, on an opposite end, with an outer disc fixed to the projection blocks, a driving disc and a driven disc that correspond to each other being arranged between the annular stop plate of the pushing member and the outer disc, the driving and driven discs having vertical faces that are opposite to each other and are respectively formed with at least two curved guide grooves having identical depth contour extending from a deep end to a shallow end and opposite to each other, the opposite curved guide grooves comprising a guide bead interposed therebetween, the ball arresting assembly comprising an elastic annular plate arranged on a rear wall surface of the outer enclosure sleeve for position returning as being pushed by the pushing member.

4. The variable speed mechanism according to claim 3, wherein the center of the inner tooth sleeve of the clutching assembly of the first clutch is formed with a toothed hole for engagement with a first toothed section of the driving shaft, the outer circumference of the inner tooth sleeve being formed with elongated teeth extending in an axial direction, the inner circumference of the outer enclosure sleeve of the clutching assembly of the first clutch comprising a plurality of raised tooth bars, the first and second clamp plates of the lining assembly of the clutching assembly of the first clutch being respectively engageable with the elongated teeth of the inner tooth sleeve and the raised tooth bars of the outer enclosure sleeve.

5. The variable speed mechanism according to claim 3, wherein the inner tooth sleeve of the clutching assembly of the first clutch is formed, on an outer circumference of a rear end thereof, with a rear stepped section and a rear position-constraining annular slot for mounting the one-way bearing and the thrust bearing, the rear position-constraining annular slot receiving an inner circumference of a pressing lid, which is in the form of an annular lid made up of two parts mating with and jointed to each other, to fit therein, the inner tooth sleeve being formed, on an outer circumference of a front end thereof, with a front stepped section and a front position-constraining annular slot, the outer enclosure sleeve being formed, on a rear portion of an inner circumference thereof, with a stepped shaft hole for mounting the one-way bearing and the thrust bearing, the ball arresting assembly of the first clutch comprising a shaft sleeve that is formed of two semi-circles mating and jointed to each other and mounted to the front stepped section of the inner tooth sleeve, the shaft sleeve being formed, on an inner circumference thereof, with a retention rim corresponding to the front position-constraining annular slot of the front stepped section to allow for modularization of the clutching assembly.

6. The variable speed mechanism according to claim 3, wherein the lining assembly of the clutching assembly of the first clutch and a rear wall surface of the outer enclosure sleeve are provided with an elastic body therebetween for providing an effect of compensative energy accumulation when the lining assembly compresses the elastic body.

7. The variable speed mechanism according to claim 3, wherein the driving disc of the ball arresting assembly of the first clutch is rotatably mounted, by means of a lining sleeve and a lining plate assembly, to the front stepped section of the inner tooth sleeve, the driving and driven discs being respectively formed, on surfaces thereof that face each other, with stepped annular surfaces that correspond to each other, the curved guide grooves being formed on vertical faces of the stepped annular surfaces that are opposite to each other, wherein a spacer plate is arranged between the driven disc and the lining assembly of the clutching assembly for reducing wear and abrasion.

8. The variable speed mechanism according to claim 3, wherein the ball arresting assembly of the first clutch is provided with a driving assembly that operates the driving disc; and
the driving assembly comprises a fixing lid that is fit, through a bearing, to the shaft sleeve of the ball arresting assembly, the fixing lid comprising a plurality of guide holes set at equal angular interval, the guide holes respectively receiving guide posts formed on a corresponding surface of the driven disc of the ball arresting assembly to slidably extend therethrough, the fixing lid comprising a fixing plate, the fixing plate being provided with a servo motor mounted thereto, the servo motor comprising a driving gear, the driving gear corresponding to the driving disc of the ball arresting assembly of the first clutch, the driving disc having a circumference that comprises an engagement toothed section that engages with the driving gear.

9. The variable speed mechanism according to claim 3, wherein the center of the inner tooth sleeve of the clutching assembly of the second clutch is formed with a toothed hole for engagement with a second toothed section of the driving shaft, the inner tooth sleeve having an outer circumference formed with elongated teeth that extend axially, the outer enclosure sleeve of the clutching assembly of the second clutch having an inner circumference comprising a plurality of raised tooth bars, the first clamp plates of the lining assembly of the clutching assembly of the second clutch being engageable, through engagement teeth formed on an inner circumference thereof, with the elongated teeth of the inner tooth sleeve, the second clamp plates being engageable, through engagement teeth formed on an outer circumference thereof, with he raised tooth bars of the outer enclosure sleeve.

10. The variable speed mechanism according to claim 3, wherein the inner tooth sleeve of the clutching assembly of the second clutch is formed, on outer circumferences of two ends thereof, with stepped sections for rotatably supporting, through a front thrust bearing and a rear thrust bearing, the radial support member and the outer enclosure sleeve, the outer enclosure sleeve of the clutching assembly of the second clutch being formed, in a center of a wall surface thereof, with a shaft seat hole for mounting the rear thrust bearing, the inner tooth sleeve being provided, in the rear-end stepped section, with a position-constraining annular slot extending beyond the rear thrust bearing to allow two pressing plates that are received in the position-constraining annular slot of the inner tooth sleeve to be mounted to the rear wall surface of the outer enclosure sleeve, the radial support member being formed, in a center thereof, with a stepped shaft seat hole for mounting the front thrust bearing, the shaft seat hole being formed, in an inner circumference thereof at a location adjacent to a front end, with a retention groove to receive a retention ring to fit therein to retain the front thrust bearing on the radial support member.

11. The variable speed mechanism according to claim 3, wherein an elastic body is arranged between the lining assembly of the clutching assembly of the second clutch and a rear wall surface of the outer enclosure sleeve for providing an effect of compensative energy accumulation when the lining assembly compresses the elastic body.

12. The variable speed mechanism according to claim 3, wherein the pushing member of the ball arresting assembly of the second clutch has an outer circumference receiving a lining sleeve fit thereto and the driving and driven discs are fit to the lining sleeve.

13. The variable speed mechanism according to claim 3, wherein the driven disc of the ball arresting assembly of the second clutch and the annular stop plate of the pushing member are formed, on opposite surfaces thereof, with annular bead grooves corresponding to each other to receive therein at least two corresponding rolling beads to roll therein, the driving disc of the ball arresting assembly of the second clutch and the outer disc being formed, on surfaces thereof, with corresponding annular bead grooves to receive at least two corresponding rolling beads to roll therein.

14. The variable speed mechanism according to claim 3, wherein the outer disc of the ball arresting assembly of the second clutch comprises an inner hole corresponding to the outer enclosure sleeve and the inner hole is formed with a plurality of projecting retention blocks that are different in position from the projection blocks of the outer enclosure sleeve of the clutching assembly of the second clutch, the outer enclosure sleeve being formed, in an outer edge of each of the projection blocks, with an annular engagement slot to allow the ball arresting assembly to be retained on the outer enclosure sleeve of the clutching assembly of the second clutch by the outer disc.

15. The variable speed mechanism according to claim 14, wherein the radial support member of the clutching assembly of the second clutch comprises a plurality of rib strips corresponding to the outer disc and the rib strips are each provided, on a top end thereof, with a fitting tooth groove corresponding to the projecting retention block so that the radial support member and the outer disc retained together and rotatable in synchronization with each other.

16. The variable speed mechanism according to claim 3, wherein the ball arresting assembly of the second clutch is further provided with a driving assembly for rotating the driving disc; and
the driving assembly comprises a fixing annular cover fit to the driven disc of the ball arresting assembly, the fixing annular cover being provided with a servo motor mounted thereto, the servo motor comprising a driving gear corresponding to the driving disc of the ball arresting assembly, the driving disc having a circumference comprising an engagement toothed section engageable with the driving gear so that the servo motor selectively operates the driving disc of the ball arresting assembly to rotate forward and backward.

17. A variable speed mechanism, wherein the variable speed mechanism is provided, on a driving shaft, with at least two clutches for using the different clutches to selectively drive at least two corresponding transmission wheels having different gear ratios so as to drive, through the transmission wheels, a driven wheel to generate different rotational speeds, the clutches each comprising at least a clutching assembly and a ball arresting assembly;
wherein the clutching assembly at least comprises an inner tooth sleeve, a lining assembly, and an outer enclosure sleeve, the inner tooth sleeve being engageable, at a center thereof, with the driving shaft, the outer enclosure sleeve being mounted, through a one-way bearing and a thrust bearing, to the inner tooth sleeve, the lining assembly of the clutching assembly comprising a plurality of first clamp plates and second clamp plates that are arranged adjacent to each other and are respectively coupled to an outer circumference of the inner tooth sleeve and an inner circumference of the outer enclosure sleeve for being selectively compressed to get in tight engagement, the outer enclosure sleeve being coupled to a corresponding one of the transmission wheels; and
the ball arresting assembly comprises a driving disc and a driven disc rotatably mounted to a front end of the inner tooth sleeve, the driving and driven discs having vertical faces that are opposite to each other and are respectively formed with at least two curved guide grooves having identical depth contour extending from a deep end to a shallow end and opposite to each other, the opposite curved guide grooves comprising a guide bead interposed therebetween so that forward and backward rotation between the driving and driven discs generate movements of leaving and approaching each other, respectively.

18. The variable speed mechanism according to claim 17, wherein the center of the inner tooth sleeve of the clutching assembly is formed with a toothed hole for engagement with a toothed section of the driving shaft, the outer circumference of the inner tooth sleeve being formed with elongated teeth extending in an axial direction, the inner circumference of the outer enclosure sleeve of the clutching assembly comprising a plurality of raised tooth bars, the first and second clamp plates of the lining assembly of the clutching assembly being respectively engageable with the elongated teeth of the inner tooth sleeve and the raised tooth bars of the outer enclosure sleeve.

19. The variable speed mechanism according to claim 17, wherein the inner tooth sleeve of the clutching assembly is formed, on an outer circumference of a rear end thereof, with a rear stepped section and a rear position-constraining annular slot for mounting the one-way bearing and the thrust bearing, the rear position-constraining annular slot receiving an inner circumference of a pressing lid, which is in the form of an annular lid made up of two parts mating with and jointed to each other, to fit therein, the inner tooth sleeve being formed, on an outer circumference of a front end thereof, with a front stepped section and a front position-constraining annular slot, the outer enclosure sleeve being formed, on a rear portion of an inner circumference thereof, with a stepped shaft hole for mounting the one-way bearing and the thrust bearing, the ball arresting assembly comprising a shaft sleeve that is formed of two semi-circles mating and jointed to each other and mounted to the front stepped section of the inner tooth sleeve, the shaft sleeve being formed, on an inner circumference thereof, with a retention rim corresponding to the front position-constraining annular slot of the front stepped section to allow for modularization of the clutching assembly.

20. The variable speed mechanism according to claim 17, wherein the lining assembly of the clutching assembly and a rear wall surface of the outer enclosure sleeve are provided with an elastic body therebetween for providing an effect of compensative energy accumulation when the lining assembly compresses the elastic body.

21. The variable speed mechanism according to claim 17, wherein the driving disc of the ball arresting assembly is rotatably mounted, by means of a lining sleeve and a lining plate assembly, to the front stepped section of the inner tooth sleeve, the driving and driven discs being respectively formed, on surfaces thereof that face each other, with stepped annular surfaces that correspond to each other, the curved guide grooves being formed on vertical faces of the stepped annular surfaces that are opposite to each other, wherein a spacer plate is arranged between the driven disc and the lining assembly of the clutching assembly for reducing wear and abrasion.

22. The variable speed mechanism according to claim 17, wherein the ball arresting assembly is provided with a driving assembly that operates the driving disc; and
the driving assembly comprises a fixing lid that is fit, through a bearing, to the shaft sleeve of the ball arresting assembly, the fixing lid comprising a plurality of guide holes set at equal angular interval, the guide holes respectively receiving guide posts formed on a corresponding surface of the driven disc of the ball arresting assembly to slidably extend therethrough, the fixing lid comprising a fixing plate, the fixing plate being provided with a servo motor mounted thereto, the servo motor comprising a driving gear, the driving gear corresponding to the driving disc of the ball arresting assembly, the driving disc having a circumference that comprises an engagement toothed section that engages with the driving gear.

23. A variable speed mechanism, wherein the variable speed mechanism is provided, on a driving shaft, with at least two clutches for using the different clutches to selectively drive at least two corresponding transmission wheels having different gear ratios so as to drive, through the transmission wheels, a driven wheel to generate different rotational speeds, the clutches each comprising at least a clutching assembly and a ball arresting assembly;
wherein the clutching assembly at least comprises an inner tooth sleeve, a lining assembly, an outer enclosure sleeve having an opening, and a radial support member, the inner tooth sleeve being engageable, at a center thereof, with the driving shaft, the radial support member and the outer enclosure sleeve having centers respectively and rotatably mounted to two ends of the inner tooth sleeve, the lining assembly comprising a plurality of first clamp plates and second clamp plates that are arranged adjacent to each other and are respectively coupled to an outer circumference of the inner tooth sleeve and an inner circumference of the outer enclosure sleeve for being selectively compressed to get in tight engagement, the open end of the outer enclosure sleeve being formed, on a circumference thereof, with a plurality of equally-spaced projection blocks, the outer enclosure sleeve being coupled to a corresponding one of the transmission wheels; and
the ball arresting assembly comprises a pushing member fit to an outer circumference of the outer enclosure sleeve, the pushing member being extended, corresponding to a rear end, to form an annular stop plate, the pushing member having a front end that is formed with a push plate that is curved inwardly for extension through and abutting, in a rearward direction, the lining assembly, the push plate being formed with a plurality of through holes respectively corresponding to the projection blocks of the circumference of the open end of the outer enclosure sleeve, the outer enclosure sleeve being provided, on an opposite end, with an outer disc fixed to the projection blocks, a driving disc and a driven disc that correspond to each other being arranged between the annular stop plate of the pushing member and the outer disc, the driving and driven discs having vertical faces that are opposite to each other and are respectively formed with at least two curved guide grooves having identical depth contour extending from a deep end to a shallow end and opposite to each other, the opposite curved guide grooves comprising a guide bead interposed therebetween, the ball arresting assembly comprising an elastic annular plate arranged on a rear wall surface of the outer enclosure sleeve for position returning as being pushed by the pushing member.

24. The variable speed mechanism according to claim 23, wherein the center of the inner tooth sleeve of the clutching assembly is formed with a toothed hole for engagement with a toothed section of the driving shaft, the inner tooth sleeve having an outer circumference formed with elongated teeth that extend axially, the outer enclosure sleeve having an inner circumference comprising a plurality of raised tooth bars, the first clamp plates of the lining assembly being engageable, through engagement teeth formed on an inner circumference thereof, with the elongated teeth of the inner tooth sleeve, the second clamp plates being engageable, through engagement teeth formed on an outer circumference thereof, with he raised tooth bars of the outer enclosure sleeve.

25. The variable speed mechanism according to claim 23, wherein the inner tooth sleeve is formed, on outer circumferences of two ends thereof, with stepped sections for rotatably supporting, through a front thrust bearing and a rear thrust bearing, the radial support member and the outer enclosure sleeve, the outer enclosure sleeve being formed, in a center of a wall surface thereof, with a shaft seat hole for mounting the rear thrust bearing, the inner tooth sleeve being provided, in the rear-end stepped section, with a position-constraining annular slot extending beyond the rear thrust bearing to allow two pressing plates that are received in the position-constraining annular slot of the inner tooth sleeve to be mounted to the rear wall surface of the outer enclosure sleeve, the radial support member being formed, in a center thereof, with a stepped shaft seat hole for mounting the front thrust bearing, the shaft seat hole being formed, in an inner circumference thereof at a location adjacent to a front end, with a retention groove to receive a retention ring to fit therein to retain the front thrust bearing on the radial support member.

26. The variable speed mechanism according to claim 23, wherein an elastic body is arranged between the lining assembly and a rear wall surface of the outer enclosure sleeve for providing an effect of compensative energy accumulation when the lining assembly compresses the elastic body.

27. The variable speed mechanism according to claim 23, wherein the pushing member of the ball arresting assembly has an outer circumference receiving a lining sleeve fit thereto and the driving and driven discs are fit to the lining sleeve.

28. The variable speed mechanism according to claim 23, wherein the driven disc of the ball arresting assembly and the annular stop plate of the pushing member are formed, on opposite surfaces thereof, with annular bead grooves corresponding to each other to receive therein at least two corresponding rolling beads to roll therein, the driving disc of the ball arresting assembly and the outer dis being formed, on surfaces thereof, with corresponding annular bead grooves to receive at least two corresponding rolling beads to roll therein.

29. The variable speed mechanism according to claim 23, wherein the outer disc of the ball arresting assembly comprises an inner hole corresponding to the outer enclosure sleeve and the inner hole is formed with a plurality of projecting retention blocks that are different in position from the projection blocks of the outer enclosure sleeve, the outer enclosure sleeve being formed, in an outer edge of each of the projection blocks, with an annular engagement slot to allow the ball arresting assembly to be retained on the outer enclosure sleeve by the outer disc.

30. The variable speed mechanism according to claim 29, wherein the radial support member comprises a plurality of rib strips corresponding to the outer disc and the rib strips are each provided, on a top end thereof, with a fitting tooth groove corresponding to the projecting retention block so that the radial support member and the outer disc retained together and rotatable in synchronization with each other.

31. The variable speed mechanism according to claim 23, wherein the ball arresting assembly is further provided with a driving assembly for rotating the driving disc; and
the driving assembly comprises a fixing annular cover fit to the driven disc of the ball arresting assembly, the fixing annular cover being provided with a servo motor mounted thereto, the servo motor comprising a driving gear corresponding to the driving disc of the ball arresting assembly, the driving disc having a circumference comprising an engagement toothed section engageable with the driving gear so that the servo motor selectively operates the driving disc of the ball arresting assembly to rotate forward and backward.

32. The variable speed mechanism according to claim 4, wherein the inner tooth sleeve of the clutching assembly of the first clutch is formed, on an outer circumference of a rear end thereof, with a rear stepped section and a rear position-constraining annular slot for mounting the one-way bearing and the thrust bearing, the rear position-constraining annular slot receiving an inner circumference of a pressing lid, which is in the form of an annular lid made up of two parts mating with and jointed to each other, to fit therein, the inner tooth sleeve being formed, on an outer circumference of a front end thereof, with a front stepped section and a front position-constraining annular slot, the outer enclosure sleeve being formed, on a rear portion of an inner circumference thereof, with a stepped shaft hole for mounting the one-way bearing and the thrust bearing, the ball arresting assembly of the first clutch comprising a shaft sleeve that is formed of two semi-circles mating and jointed to each other and mounted to the front stepped section of the inner tooth sleeve, the shaft sleeve being formed, on an inner circumference thereof, with a retention rim corresponding to the front position-constraining annular slot of the front stepped section to allow for modularization of the clutching assembly.

33. The variable speed mechanism according to claim 9, wherein the inner tooth sleeve of the clutching assembly of the second clutch is formed, on outer circumferences of two ends thereof, with stepped sections for rotatably supporting, through a front thrust bearing and a rear thrust bearing, the radial support member and the outer enclosure sleeve, the outer enclosure sleeve of the clutching assembly of the second clutch being formed, in a center of a wall surface thereof, with a shaft seat hole for mounting the rear thrust bearing, the inner tooth sleeve being provided, in the rear-end stepped section, with a position-constraining annular slot extending beyond the rear thrust bearing to allow two pressing plates that are received in the position-constraining annular slot of the inner tooth sleeve to be mounted to the rear wall surface of the outer enclosure sleeve, the radial support member being formed, in a center thereof, with a stepped shaft seat hole for mounting the front thrust bearing, the shaft seat hole being formed, in an inner circumference thereof at a location adjacent to a front end, with a retention groove to receive a retention ring to fit therein to retain the front thrust bearing on the radial support member.

34. The variable speed mechanism according to claim 12, wherein the driven disc of the ball arresting assembly of the second clutch and the annular stop plate of the pushing member are formed, on opposite surfaces thereof, with annular bead grooves corresponding to each other to receive therein at least two corresponding rolling beads to roll therein, the driving disc of the ball arresting assembly of the second clutch and the outer disc being formed, on surfaces thereof, with corresponding annular bead grooves to receive at least two corresponding rolling beads to roll therein.

35. The variable speed mechanism according to claim 18, wherein the inner tooth sleeve of the clutching assembly is formed, on an outer circumference of a rear end thereof, with a rear stepped section and a rear position-constraining annular slot for mounting the one-way bearing and the thrust bearing, the rear position-constraining annular slot receiving an inner circumference of a pressing lid, which is in the form of an annular lid made up of two parts mating with and jointed to each other, to fit therein, the inner tooth sleeve being formed, on an outer circumference of a front end thereof, with a front stepped section and a front position-constraining annular slot, the outer enclosure sleeve being formed, on a rear portion of an inner circumference thereof, with a stepped shaft hole for mounting the one-way bearing and the thrust bearing, the ball arresting assembly comprising a shaft sleeve that is formed of two semi-circles mating and jointed to each other and mounted to the front stepped section of the inner tooth sleeve, the shaft sleeve being formed, on an inner circumference thereof, with a retention rim corresponding to the front position-constraining annular slot of the front stepped section to allow for modularization of the clutching assembly.

36. The variable speed mechanism according to claim 24, wherein the inner tooth sleeve is formed, on outer circumferences of two ends thereof, with stepped sections for rotatably supporting, through a front thrust bearing and a rear thrust bearing, the radial support member and the outer enclosure sleeve, the outer enclosure sleeve being formed, in a center of a wall surface thereof, with a shaft seat hole for mounting the rear thrust bearing, the inner tooth sleeve being provided, in the rear-end stepped section, with a position-constraining annular slot extending beyond the rear thrust bearing to allow two pressing plates that are received in the position-constraining annular slot of the inner tooth sleeve to be mounted to the rear wall surface of the outer enclosure sleeve, the radial support member being formed, in a center thereof, with a stepped shaft seat hole for mounting the front thrust bearing, the shaft seat hole being formed, in an inner circumference thereof at a location adjacent to a front end, with a retention groove to receive a retention ring to fit therein to retain the front thrust bearing on the radial support member.

37. The variable speed mechanism according to claim 27, wherein the driven disc of the ball arresting assembly and the annular stop plate of the pushing member are formed, on opposite surfaces thereof, with annular bead grooves corresponding to each other to receive therein at least two corresponding rolling beads to roll therein, the driving disc of the ball arresting assembly and the outer dis being formed, on surfaces thereof, with corresponding annular bead grooves to receive at least two corresponding rolling beads to roll therein.
